(19) United States
(12) Patent Application Publication
(10) Pub. No.: US 2025/0035774 A1
(43) Pub. Date: Jan. 30, 2025

(54) SYSTEMS AND METHODS FOR ANTENNA-TO-HUMAN PROXIMITY DETECTION AND CLASSIFICATION

(71) Applicant: Intel Corporation, Santa Clara, CA (US)

(72) Inventors: Qing De XIA, Shanghai (CN); Yan LU, Shanghai (CN); Ji ZHANG, Shanghai (CN); Juan ZOU, Shanghai (CN); Matan LEVY, Tzur Moshe (IL); Joy PODDAR, Bangalore (IN); Amir RUBIN, Kiryat Ono (IL); Amit SINGHAL, Bangalore (IN)

(21) Appl. No.: 18/835,028

(22) PCT Filed: Feb. 2, 2023
(86) PCT No.: PCT/US2023/061796

§ 371 Date: Aug. 1, 2024

(30) Foreign Application Priority Data
Mar. 2, 2022 (WO) PCT/CN2022/078758

(51) Int. Cl. G01S 13/88; G01S 13/36; H04B 1/3827

(52) U.S. Cl. CPC G01S 13/88; G01S 13/36; H04B 1/3827

(57) ABSTRACT

Disclosed herein are devices, systems, and methods for detecting and classifying the proximity of a human to a wireless antenna. The device may include a processor configured to receive information representing an incident wave and a reflected wave of a transmission on the wireless antenna. The processor may also be configured to analyze the information using one or more classification models, wherein each of the one or more classification models comprise a machine-learning-based classifier that determines, based on the information, whether the object is within a threshold proximity to the wireless antenna, a classification of the object, and/or a separation-distance between the wireless antenna and the object.

### CROSS-REFERENCE TO RELATED APPLICATION(S)

This application claims priority to patent application No. PCT/CN2022/078758 filed on Mar. 2, 2022, the entire contents of which are incorporated herein by reference.

### TECHNICAL FIELD

The disclosure relates generally to wireless devices, and in particular to antenna-to-human proximity detection in order to detect when a human is near an antenna of a wireless device.

### BACKGROUND

Specific Absorption Rate (SAR) is a measure of the amount of radio-frequency (RF) energy absorbed by the human body when an electronic device is in its wireless transmission (TX) mode. Due to human safety concerns, many governments impose limits to the amount of energy that may be emitted by transmissions of a wireless device when a human (or body part thereof) is near the antenna. The allowed SAR value is often dependent upon TX power levels, the body parts that are in proximity to the antenna, and the separation-distance between human body part and the transmitting antenna. As a result, wireless devices may need to back-off transmission power level to adhere to the permitted level when a human (or body part thereof) is near the TX antenna. While systems currently exist for detecting whether a body part is near an antenna, but they are not reliable, not able to determine the separation distance between the body part and the antenna, and not able to determine which type of body part is near the antenna.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an exemplary antenna-to-human proximity detection system;

FIG. 2A shows exemplary accuracy and loss results for body part classification that may be obtained by a data vector-based antenna-to-human proximity detection system;

FIG. 2B shows exemplary accuracy and loss results for body part classification that may be obtained based on data such as voltage standing wave ratio (VSWR);

FIG. 3A shows exemplary accuracy and loss results for separation distance classification that may be obtained by a data vector-based antenna-to-human proximity detection system;

FIG. 3B shows exemplary accuracy and loss results for separation distance classification that may be obtained based on data such as voltage standing wave ratio (VSWR);

FIG. 4A shows exemplary accuracy and loss results for human proximity classification that may be obtained by a data vector-based antenna-to-human proximity detection system;

FIG. 4B shows exemplary accuracy and loss results for human proximity classification that may be obtained based on data such as VSWR;

FIG. 5 illustrates an exemplary schematic drawing of a device for data vector-based antenna-to-human proximity detection; and

FIG. 6 depicts an exemplary schematic flow diagram of a method for data vector-based antenna-to-human proximity detection.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

As noted above, existing Specific Absorption Rate (SAR) detection systems may be able to detect whether a body part is near an antenna, but they may not be reliable, may not able to determine the separation distance between the body part and the antenna, and may not able to determine which type of body part is near the antenna. As a result, RF transmissions may be not be optimized for the given situation, and the power of the RF transmissions may be backed-off more than is necessary.

Disclosed herein is an antenna-to-human proximity detection device, which not only supports a binary (e.g., true/false) detection of whether a human is within a certain proximity to an RF transmission antenna but also provides for (1) determining the separation distance between the antenna and a human body part and (2) determining a classification of which body part(s) are near the antenna (e.g., limbs, head, torso, and so on). The antenna-to-human proximity detection device may then use the determined separation distance and the determined type of body part to fine-tune the TX power back-off for RF transmissions from the antenna. With a fine-grain, sophisticated TX power back-off power control, the RF transmissions may be tuned to meet the necessary TX back-off level to comply with applicable SAR standards (e.g., to meet the applicable government's standards related to SAR) while also ensuring an optimal wireless transmission performance, as discussed in more detail below. In addition, the disclosure below provides a brief proof-of-concept evaluation result, showing that the disclosed antenna-to-human proximity detection device may achieve very satisfactory results (e.g., >97.7%-100% accuracy), with very limited memory (e.g., double-data rate (DDR) memory) and processing (e.g., central processing unit (CPU) resource consumption).

Conventional solutions for TX power back-off generally involve two kinds of proximity detection approaches, either a dedicated capacitive sensor approach or a reflection-coefficient/return-loss/VSWR measurement approach. A dedicated capacitive sensor approach relies on a dedicated proximity sensor. Usually, the proximity sensor is a capacitive sensor that is collocated with, overlapping with, or adjacent to the antenna. When a user moves within a pre-defined distance threshold (e.g., within 20 mm), the proximity sensor triggers a “true” indication. When user moves outside of the distance threshold (which may also include a hysteresis), the sensor triggers a “false” indication. Based on the true/false indicator from the proximity sensor, the wireless device controller may activate/deactivate the TX power back-off for SAR-purposes that reduces the TX power when the sensor indicates “true” and reverts to a normal, higher TX power when the sensor indicates “false.”

Under a reflection-coefficient/return-loss/VSWR measurement approach, it may be based on a reflection coefficient (T), return loss (RL), or voltage standing wave ratio (VSWR). The basic principle is that, when a human is near the TX antenna, it impacts the antenna performance such that more radio energy is reflected than is radiated into the air. As such, the proximity of a human to a transmitting antenna may change the value of the reflection coefficient. RL and VSWR are different measurement metrics but are essentially interchangeable with reflection coefficient, where both RL and VSWR may be derived from reflection coefficient measurements and therefore their values may change as a function of the human's distance to the transmitting antenna. Under this approach, the value of the measurement metric (e.g., Γ, RL, or VSWR) may be compared with a pre-defined threshold value to determine whether a human body part is near the antenna (“true”) or not (“false”). If the value of the measured metric exceeds the threshold value (“true”), this may mean that a human is near the antenna, and TX power back-off may be activated. If the value of the measured metric is below the threshold value is (“false”), this may mean that a human is not near the antenna, and TX power back-off may be deactivated.

Such conventional approaches may have disadvantages, including extra costs, poor reliability and low accuracy, coarse power control, and a high rate of so-called “false positives,” where TX power back-off is activated even though there is no nearby human body part. From a cost perspective, conventional approaches may involve a dedicated physical proximity sensor, incurring an extra bill-of-materials (BOM) cost and extra wiring. These costs may be high, especially for devices with multiple wireless TX antennas, each of which may require a proximity sensor and associated wiring. For instance, where four TX antennas are used (e.g., on a laptop device), each TX antenna may need its own sensor, wiring, and General-Purpose Input-Output (GPIO) port(s). For a conventional approach based on reflection-coefficient/return-loss/VSWR measurements, this approach may not require a dedicated proximity sensor(s), but the measurements may be unreliable and inaccurate due to the fact that the measurements may vary widely from one proximity/position to another (e.g., large variations may come from different handgrips, different finger-touch positions, or different device tilt angles). Due to its unreliability and inaccuracy, this approach is rarely implemented in real-world devices.

Conventional approaches may suffer from only coarse power control that does not detect specific body-parts or the distance by which a body-part is separated from the transmitter. By using a pre-defined threshold value, such conventional approaches may only provide a binary “true” or “false” output and may not be able to determine which body part is near the antenna or what distance the antenna is separated from body part. This brings two drawbacks. First, for a wireless module intended to integrate with different host platforms or device types, the threshold may need to be adjusted depending on the host type or device type, which may incur extra engineering time and design effort. Second, the device may need to choose a coarse and conservative TX power reduction value so that the TX back-off sufficiently covers SAR limits for a range of body-parts and for a wide range of separation-distances. A larger-than-necessary TX back-off means that wireless TX performance may suffer in order to meet SAR test compliance.

Conventional approaches may also suffer from a high false positive detection rate (e.g., the approach incorrectly identifies other objects as human and the TX power back-off is enabled unnecessarily). For example, a cup of coffee, a conductive piece of plastic, or a metallic plate may be near the sensor and incorrectly detected as a human body part, and the TX power back-off is enabled unnecessarily. Because conventional approaches may not be able to distinguish a human body part from other types of objects, non-human objects may cause the conventional approach to incorrectly register the non-human object as a human object. Such false positives degrade wireless transmission performance by unnecessarily activating TX power back-off when a the false positive detected.

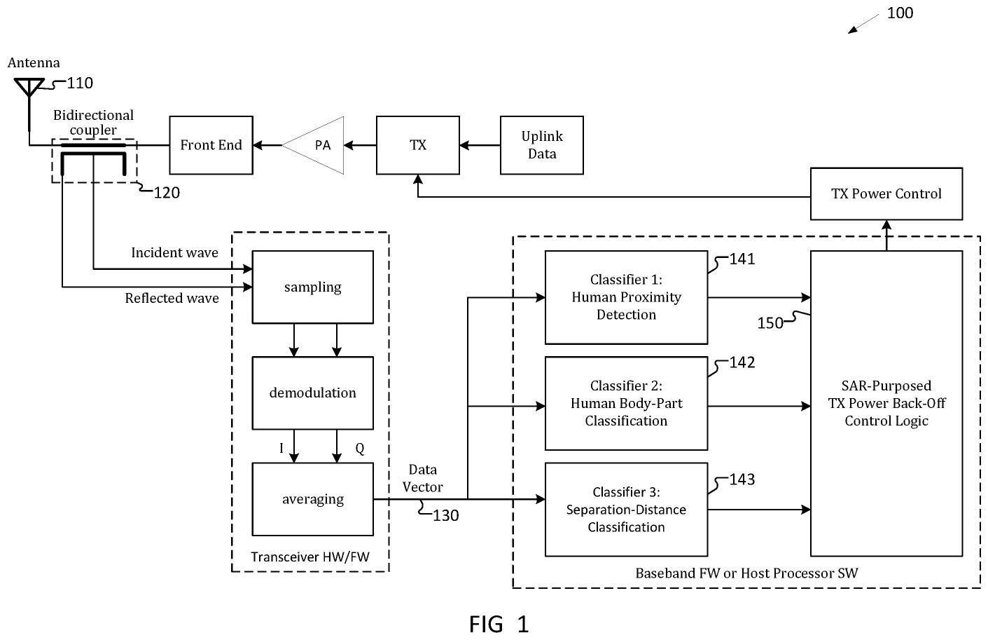

Discussed in more detail below is an improved antenna-to-human proximity detection device that may measure both the incident wave and reflected wave in-phase (I) and quadrature (Q) signals (I/Q signals) of an antenna, feed them into multiple machine-learning based classifier models, where each machine-learning model may be designed for a specific purpose, and then adjust the TX back-off according to the distance and/or object classification. The machine-learning models may work together to: (1) detect if a human is within a threshold distance to a TX antenna; (2) determine what human body-part (e.g., head, torso, limb, etc.) is within the threshold distance; and/or (3) determine the separation-distance between antenna and the detected human body part. FIG. 1 illustrates a flow diagram 100 showing an exemplary wireless device that includes the antenna-to-human proximity detection system disclosed herein.

Referring to FIG. 1, the antenna-to-human proximity detection system may include a bidirectional coupler 120 between the RF front-end and the antenna 110 that is able to make I/Q signal measurements on the modulated incident wave and reflected wave from the bidirectional coupler 120. Such a bidirectional coupler 110 may not need to be specifically added as part of the antenna-to-human proximity detection system because it is often already available as part of the wireless module (e.g., it is often available and used by the wireless module (e.g., the transmitter, receiver, and/or transceiver hardware/firmware) for other purposes (e.g., for production-line calibration etc.), such that sampling, demodulation, averaging, etc. of I/Q signal measurements may be possible without extra hardware costs. The antenna-to-human proximity detection system may utilize the I/Q signal measurements of the incident wave and reflected wave to produce a data vector 130 that includes characteristic information about the incident and reflected waves of transmissions on the antenna 110. The data vector 130 may include, as non-limiting examples, the following characteristic information measurement parameters: fw_i, fw_q, rw_i, rw_q, and rw2fw_ratio, where rw2fw_ratio is the ratio between averaged forward samples and reverse samples; fw_i, fw_q are the I/Q components of the complex averaged forward measurement; rw_i, rw_q are the I/Q components of the complex averaged reverse measurement. As should be appreciated these are merely examples of the characteristic information that may be included in the data vector 130, and the data vector 130 may include any type of information characterizing the RF transmissions on antenna 110.

The data vector 130, together with additional RF transmission parameters (such as the RF channel identifier (RF channel ID) on which the measurement is made), may be fed into any number of different machine-learning based classifier models, each of which may be designed for a specific purpose, as discussed in more detail below. For example, FIG. 1 shows three different machine-learning classifier models, a first classifier 141 (“Classifier 1”), a second classifier 142 (“Classifier 2”), and a third classifier 143 (“Classifier 3”). As should be appreciated these three classifiers are merely exemplary, and any number of classifiers may be used to provide different classifications of the RF transmissions based on any data from the data vector 130 and/or the additional RF transmission parameters. First classifier 141 may be, as one example, designed to make a Boolean (e.g., true/false) determination indicating whether a human body is within a predefined proximity distance threshold (e.g., within 2 mm) of the antenna 110.

Second classifier 142 may be designed to classify the type of body part(s) near the antenna 110, where the classifier 142 may output a type of human body part that may be detected near the antenna 110. The classification output of classifier 142 may be based on, for example, a dielectric constant of each body part, where the dielectric constant of each body part may be different and may impact the data vector 130 measurements differently. Classifier 142 may use these differences in data vector 130 measurements to distinguish among the various body parts. For example, classifier 142 may classify human body into parts like “limb,” “body,” and/or “head” based on the differences in the data vector 130 measurements. As another example, classifier 142 may provide more detailed classifications (e.g., subclassification) to distinguish among body parts classified with a higher level, general classification. For example, a classification of “limb” may have subclassifications that include “hand,” “wrist,” “foot,” “ankle,” etc. to distinguish among the different types of limbs. As should be appreciated, these classifications and subclassifications are merely exemplary, and any type/number of classifications/subclassifications may be used, which may be tailored to the specific SAR requirements of the region(s) in which the wireless device may operate.

A third classifier 143 (“Classifier 3”) may be designed to determine a separation distance between the antenna 110 and the human body part(s) based on the data vector 130 measurements. Classifier 143 may, for example, provide an absolute distance or may classify the separation distance into different distance ranges (e.g., 0 mm, ≤5 mm, ≤10 mm, and so on) indicating the range of distance in which the body part(s) are located from antenna 110.

As should be appreciated, the above-described classifiers may include other features. For example, the distance threshold for the first classifier 141 may be adjusted as desired and may be determined based on the training dataset applied to the classifier, and it may or may not be related to the other classifiers (e.g. second classifier 142 and/or third classifier 143). For example, the separation-distance range output of classifier 143 may include an output of “>20 mm” for all distances greater than 20 mm, in which case the distance threshold used to train the first classifier 141 may also be based on the same 20 mm distance threshold, in order to keep consistency between classifiers. In other words, first classifier 141 may be trained to output “False” when the distance is greater than 20 mm. As another example, it is also possible that the simple true/false human proximity classifier (e.g., first classifier 141) may be omitted when the outputs of the other two classifiers may be used to infer whether there is a human within the threshold proximity. For example, the output from third classifier 143 may serve as a “True/False” determination at the defined separation-distance threshold.

As another example, the output of the second classifier 142 or third classifier 143 may be related to or independent from the output of the first classifier 141. For instance, the system may ignore the output of second classifier 142 when the output of first classifier 141 is “False.” As another example, the system may ignore the output of the other classifiers when the second classifier 142 classifies the nearby object as “non-human.” As another example, the distance range classifications of the third classifier 143 may change, depending on body part classification output of the second classifier 142, where the separate-distance ranges are changed to smaller intervals if human body part is categorized as a “head” as compared to an “extremity.” As should be appreciated, such differences may be implementation-specific and these examples should not be understood as limiting the disclosed antenna-to-human proximity detection system.

The output of the classifiers (e.g., first classifier 141, second classifier 142, third classifier 143, etc.) may then be fed into a control logic 150 that may determine whether a transmit power back-off is necessary and, if so, an appropriate back-off amount. Control logic 150 may determine whether a transmit power back-off is necessary and the appropriate back-off amount based on the output of the classifiers and may also be based on any applicable SAR-related standards for the region in which the transmitter is operating. The power back-off amount, if any, determined by the control logic 150 may then be fed back into the TX power controller so that the TX firmware/hardware may make the corresponding power reductions.

As compared to conventional reflection-coefficient, return-loss or VSWR measurement approaches, the disclosed antenna-to-human proximity detection system may use a similar basic concept of proximity detection (e.g., when a human is near the antenna, the human's proximity causes detuning and impedance mismatch of the antenna that can be detected in changes of the incident wave and/or reflected wave). However, the specific way in which the disclosed antenna-to-human proximity detection system (e.g., antenna-to-human proximity detection system of FIG. 1) operates is different, and it may offer distinctive advantages over existing approaches. For example, the disclosed antenna-to-human proximity detection system may use, instead of a single measurement value (e.g. a reflection-coefficient, return loss, or VSWR), a data vector (e.g., data vector 130) of multiple I/Q data metrics as characteristic information about the antenna (e.g., antenna 110) that is provided as an input measurement to the control logic 150 that makes the proximity detection determinations and classifications.

In addition, instead of merely determining whether a predefined threshold distance is met, the disclosed antenna-to-human proximity detection system may use machine learning models to perform proximity detection(s), determine a distance classification(s), and/or determine a body part classification(s). In addition, while the data vector generated by the disclosed antenna-to-human proximity detection system may be used to derive the reflection coefficient, return loss, or VSWR value, these values cannot be used to generate the data vector (e.g., data vector 130). Indeed, the disclosed data vector (e.g., data vector 130) of multiple I/Q data metrics may contain much more information (e.g., amplitude and phase information) than the single value provided by a reflection coefficient, return loss, or VSWR of conventional systems. Therefore, by using a machine-learning model, the disclosed antenna-to-human proximity detection system may not only be able to detect the presence of nearby body parts and their separation distances, but it may also reliably and accurately distinguish a human object from other types of non-human objects. For example, as discussed in more detail below, exemplary evaluation results for an exemplary implementation of the disclosed antenna-to-human proximity detection system was able to achieve an accuracy of greater than 97.7%, as compared to an accuracy of 73.1%. for a conventional reflection coefficient, return loss, or VSWR-based approach.

The antenna-to-human proximity detection system may include any number of machine-learning models (e.g., neural networks). For example, the classifiers discussed above (e.g., classifier 141, classifier 142, classifier 143, etc.) may be machine-learning-based models that to determine, based on the characteristic information (e.g., any of the I/Q data metrics in data vector 130), a classification of whether, how far, and what type of body part is proximate to the antenna (e.g., antenna 110). The machine-learning-based models may be implemented as firmware running on the wireless module controller or as software running on the host platform on which the wireless module is incorporated. As should be appreciated, the machine-learning models may be “trained” with data (e.g., in a test/lab environment) before certification or widespread adoption (e.g., before SAR-certification stage and/or before end-user operation stage). The training data may be collected from real-world humans (e.g., body parts of real human) or with the human tissue-equivalent media and phantoms, as are commonly used in an SAR-test lab during SAR-certification/testing.

As noted above with respect to FIG. 1, the antenna-to-human proximity detection system may include control logic 150 for backing off the TX power based on the determined classifications (e.g., proximity characterizations such as whether the human is within a threshold distance from antenna 110, a separation distance between the human and antenna 110, and/or a type of body part that is within the threshold distance to antenna 110). The antenna-to-human proximity detection system may implement the TX power back-off control logic 150 as firmware on the wireless module baseband controller, as software on the host processor, or as distributed system among hardware, firmware, and/or software. Relying on the output of the antenna-to-human proximity detection system's classifiers, the control logic 150 may perform sophisticated TX power back-off features, including, for example, body-part specific TX power reduction values, where each classification of body part may have a different reduction value for that classification so that a single reduction value need not be used for any type of body part. The control logic 150 may also apply separation-distance specific TX power reduction values, where each determined distance or range of distances may be associated with a different power reduction value for the determined separation distance or range of distances so that a single power reduction value for one threshold distance value need not be used. The control logic 150 may also use different thresholds for activating and deactivating the power back-off for a particular separation distance classification (e.g., for hysteresis purposes to minimize on/off switching of the power back-off). The control logic 150 may also choose to use none, some, or all outputs from each of the different available classifiers (e.g., classifier 141, classifier 142, classifier 143, etc.). For instance, the control logic may choose to use only the output of classifier 141; the output of classifier 141 and classifier 142; the output of classifier 142 and classifier 143; the output of classifier 141, classifier 142, and classifier 143; and so on.

The disclosed antenna-to-human proximity detection system may provide certain advantages over conventional proximity detection systems. For example, the disclosed antenna-to-human proximity detection system may provide for optimized TX power back-off control that may be based on determined body part and/or the determined distance. This allows for fine-grained TX power reduction values and fine-tuned TX power back-off activation/deactivation control, which may vary by body-part and separation-distance. As a result, unnecessary performance degradation may be minimized while still meeting SAR compliance requirements (e.g., power back-off is set to the minimum amount for the specifics of the current situation). As another example, the antenna-to-human proximity detection system may reduce “false positive” rates and, more generally, improve reliability and accuracy of detection. A well-trained neural network classifier may be able to more precisely distinguish human tissue from other non-human objects. This may reduce the “false positive” detection rate that would otherwise result in false activation of TX power back-off, and therefore, wireless transmission performance is also improved and not unnecessarily reduced. As discussed in more detail in an example below, the classifier of the antenna-to-human proximity detection system may distinguish with high accuracy a metal shielding plate from human body at different proximity distances. In particular, the antenna-to-human proximity detection system may be able to outperform conventional return-loss/VSWR measurement-based approaches, all while still having the same cost-saving advantage. Indeed, the antenna-to-human proximity detection system does not require additional costs associated with more hardware (e.g., a proximity sensor) and associated wiring, printed circuit board space, GPIO ports, etc.

As should be understood by those in the wireless industry, the industry uses SAR test regulations/specification that may include absorption specifications related to individual body parts and their separation-distance from the antenna of a wirelessly-radiating device. Regulations and specifications for SAR compliance tests are established by national and international organizations to ensure that a device with wireless transmitting capability does not exceed the maximum SAR limits. A non-exhaustive list of SAR regulatory requirements is discussed below, including SAR-related testing for different body parts and SAR-related testing for different separation distances.

One test related to SAR regulatory requirements may include tests that are specific to different body parts (e.g., head, body, and limbs, etc.). For instance, France has regulated that SAR values for limbs should be tested in addition to SAR values for head and body. SAR for limbs may include, for example, arms, hands, wrists, feet, ankles, toes, etc. In the United States, for example, the Federal Communications Commission (FCC) requires tests against different body parts according to the device type (e.g., be it a laptop, mobile phone, or wristwatch) and usage scenarios (e.g., used in the close vicinity of body, head, or extremities). SAR evaluation for extremities is required for devices designed or intended for use on human extremities (e.g., an ankle-based wearable, a wristwatch, etc.). In such cases, the acceptable SAR limit may differ according to the body part being tested (e.g., a head may have a different limit as compared to a foot, generally because each body part may respond differently to magnetic field pulses and temperature). As one example, in North America, head and body SAR limits are at 1.6 W/kg (measured from 1-g tissue volume), while the limb SAR limit is at 4 W/g (measured from 10-g tissue volume).

Another test related to SAR regulatory requirements may include an SAR test against different separation distances between the TX antenna and the human tissue being tested (of course, in a test environment, the human tissue is often a human tissue-equivalent “phantom”), where the separation distance is defined by the device type and/or usage scenario. For instance, the FCC regulates that, for a wireless modem and antenna integrated into a laptop device, the test separation distance should be ≤25 mm when the antenna is placed in laptop display lid, while it should be ≤5 mm when the antenna is placed in the keyboard section. Similarly, other thresholds like 0 mm, 10 mm, 15 mm, and 20 mm may also be valid separation distances used in SAR testing, dependent on the specific device type, test method, and usage patterns. In addition, SAR limits may be different according to test separation distance. For instance, for certain mini-tablet devices, both 10-g extremity SAR at 0 mm distance and 1-g body SAR at 10 mm distance may be evaluated.

To pass regulatory SAR limit compliance testing, a wireless device may need to implement a mechanism called TX power back-off. TX power back-off means that when a human (or part of a human) is close to the antenna, the maximum TX power may be reduced to ensure the energy emitted from the wireless device does not exceed the allowable SAR limit. Once the antenna is distant enough from the human (or the part of the human), the original maximum TX power may be resumed, allowing for optimized wireless transmission performance. With the conventional systems, the wireless device may be able to only choose the most conservative TX power back-off value (e.g., a single back-off value that would be sufficient to meet any of the individually required separation distances for any of the individually separated body parts). This may negatively impact RF performance, especially in situations where a lower back-off power value would be permitted as compared to the single back-off value.

As discussed above, the disclosed antenna-to-human proximity detection system may resolve this performance issue by narrowly tailoring the back-off power to the particular situation. First, the system may determine the current body part and current separation distances and then it may select a power-back-off that satisfies the SAR-limit compliance requirements for that particular situation. This may minimize the impact of the power back-off to RF transmission performance.

Discussed below are non-limiting examples of an antenna-to-human proximity detection system (e.g., the antenna-to-human proximity detection system discussed above with respect to FIG. 1) that has been evaluated to assess the feasibility and accuracy of using machine-learning-based (ML-based) classifier models to detect human body proximity, classify body-parts, and classify separation-distances. In this example, three classifiers were used. Classifier 1 was for human proximity detection (e.g., first classifier 141). Classifier 2 was for body-part detection (e.g., first classifier 142). Classifier 3 was for separation-distance classification (e.g., first classifier 143). For comparison purpose, each of the classifiers has been evaluated with two kinds of input data. One kind of data is a data vector of I/Q data measurement on both forward and reflection directions (e.g., data vector 130). The other is a single VSWR parameter as input. Evaluation results shows that, with the I/Q measurement data vector as the input, all the classifiers give very promising results (97.7%˜99.9% accuracy), well outperforming the classifiers with only VSWR as an input (75%˜82% accuracy). Even with this high level of accuracy, such classifiers may be implemented, in terms of memory consumption and CPU-resource consumption, in a lightweight manner.

In terms of the evaluation configuration and methodology, for all the classifiers, a 4-layer (including input layer) fully-connected neural network model was used, as shown in the table below.

TABLE 1
neural network shape and topology for different classifiers

| | | Activation function | |
|---|---|---|---|
| Classifiers | Topology | (hidden/output layers) | Loss function |
| Body part detection | 5 × 20 × 10 × 7 | ReLU/Softmax | Categorical cross |
| | | | entropy |
| Separation-distance | 5 × 20 × 10 × 7 | ReLU/Softmax | Categorical cross |
| detection | | | entropy |
| Human proximity | 5 × 10 × 5 × 1 | ReLU/Sigmoid | Binary cross entropy |
| detection | | | |

I/Q data measurements were made with a 4G wireless wide area network (WWAN) modem. All I/Q data measurements were collected on the same LTE frequency band-1, channel ID=18300, with uplink frequency at 1950 MHz and bandwidth at 10 MHz. For each measurement, a data vector of the following five characteristic information parameters was obtained and used as classifier input: fw_i, fw_q, rw_i, rw_q, rw2fw_ratio, where:
rw2fw_ratio is the ratio between averaged forward reference samples and reverse reference samples;
fw_i, fw_q are the complex averaged forward I/Q measurements; and
rw_i, rw_q are the complex averaged reverse I/Q measurements.

As should be understood, measurements may be made across different RF bands, and the band/channel information may also be fed into the classifier model, together with the I/Q measurement data vector, at both the training and predicting stages. For illustrative purposes, the measurements herein were made only on the aforementioned single band, and the neural network classifier models have not taken channel/band information as input.

The I/Q data measurements for training and validation may be first normalized before being passed through the neural network models. Normalization may be done by subtracting the mean from the measurement, and then dividing by its standard deviation. Mean and standard deviation may be calculated from the training dataset.

For comparison purpose, classifier performance may be observed by using conventional return-loss or VSWR as a classifier input. Either of these two inputs would give similar results, so VSWR was used for comparison purposes in the graphs below to represent the conventional performance metric. The VSWR was derived from the I/Q data measurement data vector using a two-step approach. First the reflection coefficient Γ was calculated, which is a complex number, then VSWR was calculated as a real number from Γ using the equations below:

$$Γ = \frac{rw\_i + j * rw\_q}{rw2fw\_ratio * ( fw\_i + j * fw\_q )}$$

$$VSWR = \frac{1 + \vert Γ \vert}{1 - \vert Γ \vert}$$

Six different human body parts were chosen for the exemplary testing: palm, wrist, foot, ankle, cheek, and abdomen. Sets of TX I/Q measurements were collected with the antenna being placed in contact to each one of the body parts. In addition, measurements were also collected when the antenna was in open space (e.g., not proximate to a human body part), leading to seven categorical outputs, the details of which are shown in Table 2 below. In total, 1034 measurements are collected, with 70% used for training and 30% for validation.

TABLE 2
I/Q data measurements for different body parts

| | Total # of | # of dataset | # of dataset |
|---|---|---|---|
| | dataset | measurements | measurements |
| Body parts | measurements | for training | for validation |
| Open space | 147 | 102 | 45 |
| Palm | 140 | 98 | 42 |
| Wrist | 140 | 98 | 42 |
| Foot | 138 | 96 | 42 |
| Ankle | 152 | 106 | 46 |
| Cheek | 162 | 113 | 49 |
| abdomen | 155 | 108 | 47 |
| Total | 1034 | 721 | 313 |

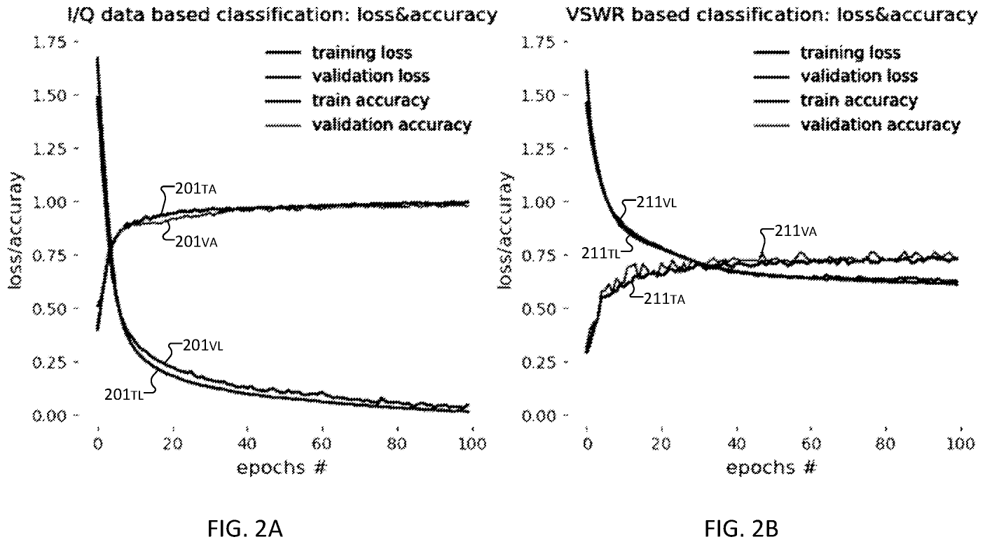

FIGS. 2A and 2B show the disclosed antenna-to-human proximity detection system classifier results using the I/Q measurement data vector (e.g., second classifier 142) as compared to conventional VSWR measurements. FIG. 2A shows the accuracy and loss results of the I/Q measurement-based classification using disclosed the antenna-to-human proximity detection system, where training loss is depicted on line 201TL, validation loss is depicted on line 201VL, training accuracy is depicted on line 201TA, and validation accuracy is depicted on line 201VA. At the end of 100 training epochs, the system obtained>99.9% accuracy for the training dataset and >97.7% accuracy for the validation dataset. As a comparison, FIG. 2B shows the accuracy and loss results when using conventional VSWR-based (or return-loss-based) measurements, where training loss is depicted on line 211TL, validation loss is depicted on line 211VL, training accuracy is depicted on line 211TA, and validation accuracy is depicted on line 211VA. The VSWR-based measurements only achieved <73.1% accuracy for both the training dataset and validation datasets.

Table 3 below summaries the exemplary datasets collected for separation-distance classification. I/Q measurements were collected with human hands being positioned with respect to the antenna at different distances: 0 mm, 5 mm, 10 mm and 15-20 mm. Additionally, measurements were also collected by placing a metal plate shielding close to the antenna, as well as by leaving the antenna in open space, to test how effectively the classifier may distinguish the different scenarios. In total, 1102 measurements were collected, with 70% used for training and 30% for validation, covering seven categorical outputs.

TABLE 3
I/Q data measurements for different separation distances

| | Total # of | # of dataset | # of dataset |
|---|---|---|---|
| | dataset | measurements | measurements |
| Body parts | measurements | for training | for validation |
| Open space | 227 | 158 | 69 |
| 0 mm | 153 | 107 | 46 |
| 5 mm | 127 | 88 | 39 |
| 10 mm | 136 | 95 | 41 |
| 15-20 mm | 132 | 92 | 40 |
| Metal shielding | 101 | 70 | 31 |
| (1-sided) | | | |
| Metal shielding | 226 | 158 | 68 |
| (2-sided) | | | |
| Total | 1102 | 768 | 334 |

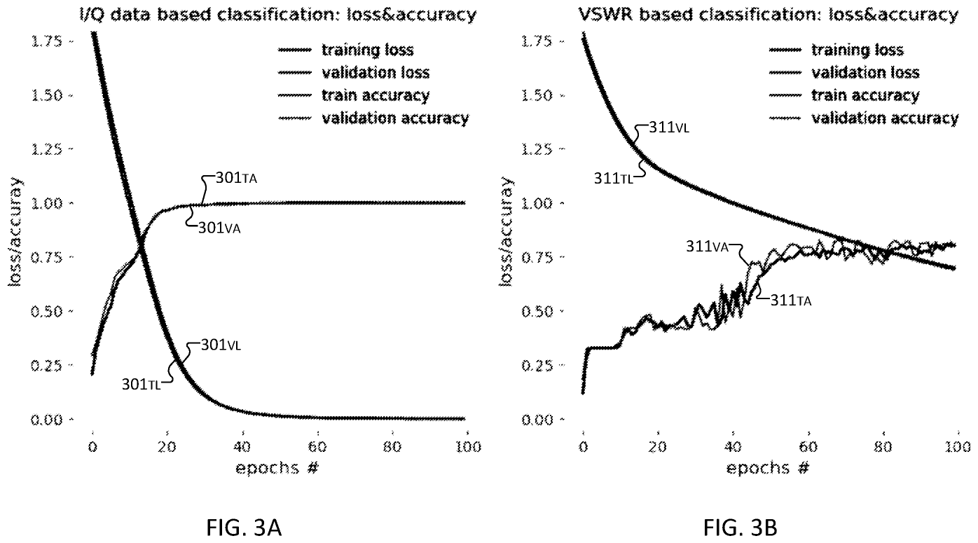

FIGS. 3A and 3B show the disclosed antenna-to-human proximity detection system separation-distance classifier results when using the I/Q measurement data vector (e.g., third classifier 143) as compared to using the conventional VSWR-based values. FIG. 3A shows the accuracy and loss results of I/Q measurement-based separation-distance classification using the disclosed the antenna-to-human proximity detection system, where training loss is depicted on line 301TL, validation loss is depicted on line 301VL, training accuracy is depicted on line 301TA, and validation accuracy is depicted on line 301VA. After 40 epochs, the disclosed antenna-to-human proximity detection system may obtain >99.9% accuracy for both the training and validation datasets. It should be noted that the result shows that the disclosed antenna-to-human proximity detection system classifier may not only detect the human body at different distances but may also distinguish human objects from non-human objects (e.g., distinguish metal shielding from a human body part). FIG. 3B shows the accuracy and loss results when using conventional VSWR-based (or return-loss-based) measurements, where training loss is depicted on line 311TL, validation loss is depicted on line 311VL, training accuracy is depicted on line 311TA, and validation accuracy is depicted on line 311VA. The VSWR-based measurements only achieved <78.0% accuracy for both the training and validation datasets, after 100 epochs.

Human proximity detection (e.g., Boolean or true/false classification of whether a human or human body part is detected) was also evaluated. For this test, the datasets from the previously discussed evaluations collected for the body-part classification and separation-distance classification were reused. The detail is listed in Table 4 below, showing human proximity detection definitions (under “Human proximity?” column) for each category of dataset.

TABLE 4
I/Q data measurements for human proximity detection

| | | | # of dataset | # of dataset |
|---|---|---|---|---|
| | Human | # of dataset | measurements | measurements |
| Body parts | proximity? | measurements | for training | for validation |
| Open space (batch 1) | False | 227 | 158 | 69 |
| 0 mm | True | 153 | 107 | 46 |
| 5 mm | True | 127 | 88 | 39 |
| 10 mm | True | 136 | 95 | 41 |
| 15-20 mm | True | 132 | 92 | 40 |
| Metal shielding (1-sided) | False | 101 | 70 | 31 |
| Metal shielding (2-sided) | False | 226 | 158 | 68 |
| Open space (batch 2) | False | 147 | 102 | 45 |
| Palm | True | 140 | 98 | 42 |
| Wrist | True | 140 | 98 | 42 |
| Foot | True | 138 | 96 | 42 |
| Ankle | True | 152 | 106 | 46 |
| Cheek | True | 162 | 113 | 49 |
| abdomen | True | 155 | 108 | 47 |

| | | | |
|---|---|---|---|
| Total (true/false) | 2136 (1435/701) | 1489 (1001/488) | 647 (434/213) |

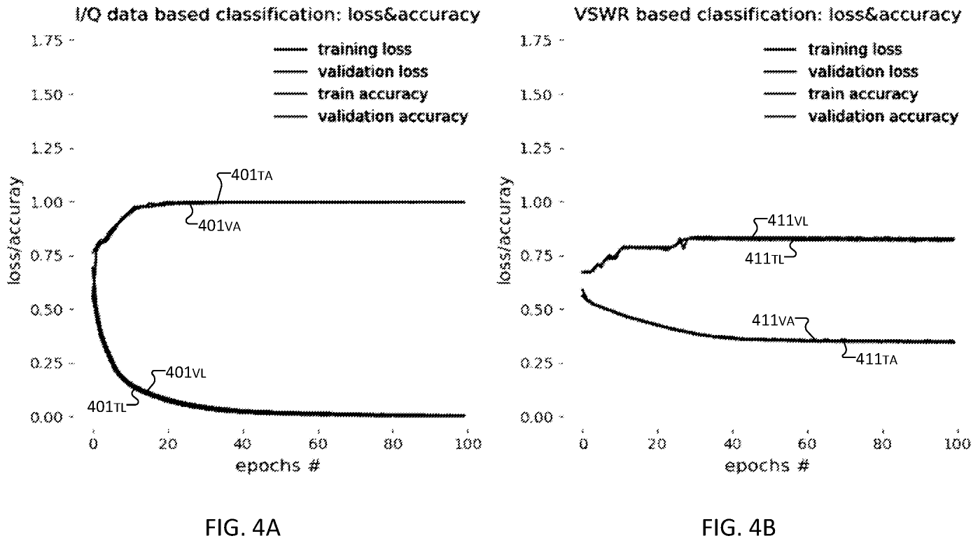

FIGS. 4A and 4B show the disclosed antenna-to-human proximity detection system human proximity detection classifier when using the I/Q measurement data vector (e.g., classifier 141) as compared to using the conventional VSWR-based values. As shown in FIG. 4A, using an I/Q measurement data vector as an input to the classifier of the disclosed the antenna-to-human proximity detection system may obtain 100% accuracy, where training loss is depicted on line 401TL, validation loss is depicted on line 401VL, training accuracy is depicted on line 401TA, and validation accuracy is depicted on line 401VA. It should also be noted that the results show that the disclosed antenna-to-human proximity detection system human proximity detection classifier may be able to not only distinguish different human body parts but may also be able to distinguish human objects from non-human objects (e.g., distinguish metal shielding from a human body part). FIG. 4B shows the accuracy and loss results using conventional VSWR-based data as an input to classification, where training loss is depicted on line 411TL, validation loss is depicted on line 411VL, training accuracy is depicted on line 411TA, and validation accuracy is depicted on line 411VA. The VSWR-based data only achieves ˜82.1% accuracy after 100 epochs.

The disclosed antenna-to-human proximity detection system may occupy only a very slim amount of memory for the code and data footprint, and it may also operate with only a small amount of computing power (e.g., CPU loading) needed. For the data footprint of such as system, the ML-based model may occupy memory (e.g., RAM) for the neural weight parameters in the neural network nodes, which is determined by the model's shape and size. Table 5 presents the data footprint for each of the classifiers used in the evaluations discussed above. In total, the data footprint amounts to <20 KB for all the three classifiers, which is a relatively small amount of occupied memory.

TABLE 5
Data footprint of each classifier, mainly
the weights used by neural networks

| | Topology | |
|---|---|---|
| Classifiers | (I/Q data as input) | Data Footprint |
| Body part detection | 5 × 20 × 10 × 7 | ≤10 KB |
| Separation-distance detection | 5 × 20 × 10 × 7 | ≤10 KB |
| Human proximity detection | 5 × 10 × 5 × 1 | ≤2 KB |

As another example, the data footprint for the code (e.g., a fully-connected neural network model, using, e.g., C++, and not relying on any existing or off-the-shelf machine-learning library/frameworks (e.g., Tensorflow, Theano, Caffe or Keras)), may be less than 50 KB, where all the classifiers share the same code base. Again, this is a relatively small footprint for the code, especially in comparison to the size of the firmware for the wireless modem itself.

The disclosed antenna-to-human proximity detection system may also consume a small amount of computing resources. Heavy use of computing-resource may come with the model-training phase, but this may be done in-lab and need not be performed using the computing resources of the wireless device itself. Once a model has been well trained and integrated into the baseband firmware, the model may simply be stored and then used for determinations at the SAR-test and end-user stages.

The determinations themselves may not demand a relatively high level of computing resources (e.g., computing capacity), and the disclosed antenna-to-human proximity detection system may not pose a large burden to the wireless controller, especially where the classification/determination may run at second-level intervals and may only need to be determined during a TX transmitting period.

The evaluations discussed above are only exemplary and should not be understood as limiting the invention. As should be appreciated, the disclosed antenna-to-human proximity detection system may apply more sophisticated algorithms for evaluating the I/Q data measurements and classifier modeling, covering additional factors which have not necessarily been discussed in the exemplary evaluation above. For example, the algorithm may also account for differences in I/Q data measurements for a wet human body versus dry human body, one individual person's body versus another individual's body, different relative angles of tilt between the antenna and the human, and any other factor that may result in differences in I/Q data measurements. Such considerations may be addressed in the antenna-to-human proximity detection system by different approaches. For instance, the machine-learning models may be trained with more diversified training datasets representative of the differences and/or the machine-learning models may be trained with full setups as used in a typical SAR-test lab (e.g., using the same tissue-equivalent media and phantoms, instead of real human parts). Because the SAR-test requirements and regulations tend to be relatively conservative, once a device is SAR-test compliant, the device may be considered safe in normal operation.

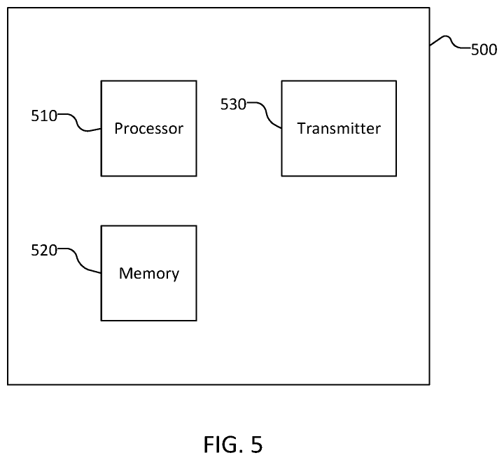

FIG. 5 is a schematic drawing illustrating a device 500 for antenna-to-human proximity detection in wireless systems. The device 700 may include any of the features discussed above with respect to the antenna-to-human proximity detection systems and any of FIGS. 1-4. FIG. 5 may be implemented as a device, a system, a method, and/or a computer readable medium that, when executed, performs the features of antenna-to-human proximity detection systems described above. It should be understood that device 500 is only an example, and other configurations may be possible that include, for example, different components or additional components.

Device 500 includes a processor 510. Processor 510 is configured to receive characteristic information about a radio frequency (RF) antenna, wherein the characteristic information represents an incident RF signal and a reflected RF signal of an RF transmission on the RF antenna. Processor 510 is also configured to analyze the characteristic information with a machine-learning-based classifier to determine, based on the characteristic information, a proximity characterization that indicates whether an object is within a threshold proximity to the RF antenna. Processor 510 is also configured to control, based on the proximity characterization, a power back-off level of the RF transmission.

Furthermore, in addition to or in combination with any one of the features of this and/or the preceding paragraph with respect to device 500, the proximity characterization may include a separation distance between the object and the RF antenna. Furthermore, in addition to or in combination with any one of the features of this and/or the preceding paragraph, processor 510 may be further configured to determine the power back-off level as a function of the separation distance. Furthermore, in addition to or in combination with any one of the features of this and/or the preceding paragraph, the proximity characterization may include a classification of the object. Furthermore, in addition to or in combination with any one of the features of this and/or the preceding paragraph, processor 510 may be further configured to determine the power back-off level as a function of the classification. Furthermore, in addition to or in combination with any one of the features of this and/or the preceding paragraph, the classification may include a type of object that is within the threshold proximity to the RF antenna. Furthermore, in addition to or in combination with any one of the features of this and/or the preceding paragraph, the type of object may include at least one of a head, a torso, a cheek, a palm, a wrist, a foot, an ankle, an abdomen, or a non-human object.

Furthermore, in addition to or in combination with any one of the features of this and/or the preceding two paragraphs with respect to device 500, the characteristic information may further include a ratio between the incident RF signal and the reflected RF signal. Furthermore, in addition to or in combination with any one of the features of this and/or the preceding two paragraphs, the ratio may include a voltage standing wave ratio (VSWR) between the incident RF signal and the reflected RF signal. Furthermore, in addition to or in combination with any one of the features of this and/or the preceding two paragraphs, the characteristic information may further include a return loss between the incident RF signal and the reflected RF signal. Furthermore, in addition to or in combination with any one of the features of this and/or the preceding two paragraphs, the characteristic information that includes the incident RF signal may include an in-phase component of the incident RF signal and a quadrature component of the incident RF signal. Furthermore, in addition to or in combination with any one of the features of this and/or the preceding two paragraphs, the characteristic information that includes the reflected RF signal may include an in-phase component of the reflected RF signal and a quadrature component of the reflected RF signal.

Furthermore, in addition to or in combination with any one of the features of this and/or the preceding three paragraphs with respect to device 500, the characteristic information may further include an RF channel of the RF transmission. Furthermore, in addition to or in combination with any one of the features of this and/or the preceding three paragraphs, the characteristic information may further include an operating temperature at the RF antenna. Furthermore, in addition to or in combination with any one of the features of this and/or the preceding three paragraphs, the characteristic information may further include a frequency band of the RF transmission. Furthermore, in addition to or in combination with any one of the features of this and/or the preceding three paragraphs, device 500 may further include a memory 520 configured to store the machine-learning-based classifier. Furthermore, in addition to or in combination with any one of the features of this and/or the preceding three paragraphs, device 500 may further include the RF antenna.

Furthermore, in addition to or in combination with any one of the features of this and/or the preceding four paragraphs with respect to device 500, processor 510 configured to control the power back-off level of the RF transmission may include processor 510 configured to send an instruction to a transceiver 530 that is coupled to the RF antenna, wherein the instruction indicates the power back-off level. Furthermore, in addition to or in combination with any one of the features of this and/or the preceding four paragraphs, device 500 may further include the transceiver 530. Furthermore, in addition to or in combination with any one of the features of this and/or the preceding four paragraphs, processor 510 configured to analyze the characteristic information may include processor 510 configured to analyze the characteristic information with a plurality of machine-learning-based classifiers, each associated with a corresponding one of a plurality of proximity classifications, wherein the machine-learning-based classifier includes one of the plurality of machine-learning-based classifiers and the proximity classification includes one of the plurality of proximity classifications. Furthermore, in addition to or in combination with any one of the features of this and/or the preceding four paragraphs, the characteristic information may include an input to the machine-learning-based classifier and the proximity characterization may include an output of the machine-learning-based classifier. Furthermore, in addition to or in combination with any one of the features of this and/or the preceding four paragraphs, the characteristic information may include an average of measured samples of the incident RF signal and the reflected RF signal.

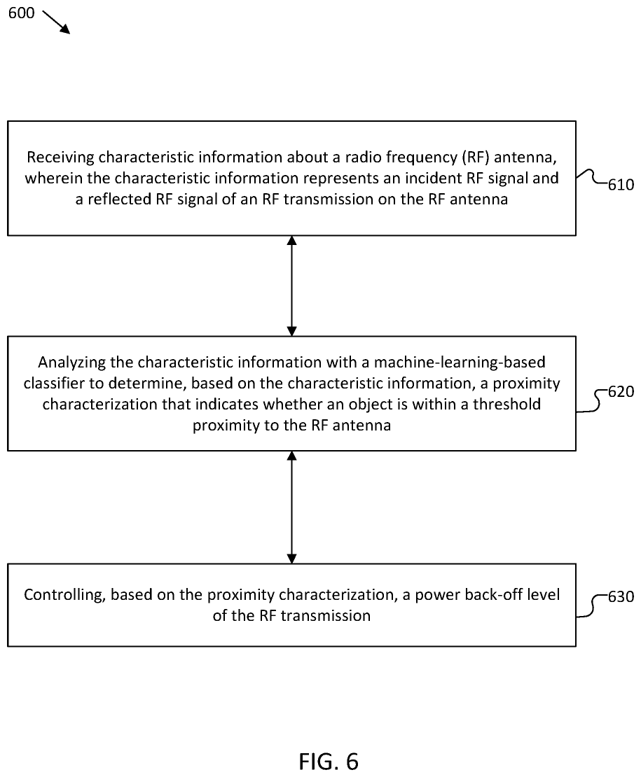

FIG. 6 depicts a schematic flow diagram of a method 600 for antenna-to-human proximity detection in wireless systems. Method 600 may implement any of the features described above with reference to the disclosed antenna-to-human proximity detection systems and any of FIGS. 1-5.

Method 600 includes, in 610, receiving characteristic information about a radio frequency (RF) antenna, wherein the characteristic information represents an incident RF signal and a reflected RF signal of an RF transmission on the RF antenna. Method 600 also includes, in 620, analyzing the characteristic information with a machine-learning-based classifier to determine, based on the characteristic information, a proximity characterization that indicates whether an object is within a threshold proximity to the RF antenna. Method 600 also includes, in 630, controlling, based on the proximity characterization, a power back-off level of the RF transmission

In the following, various examples are provided that may include one or more features described above with reference to the antenna-to-human proximity detection systems, methods, and devices and any of FIGS. 1-6. The examples provided in relation to the devices may apply also to the described method(s), and vice versa.

Example 1 is a device including a processor configured to receive characteristic information about a radio frequency (RF) antenna, wherein the characteristic information represents an incident RF signal and a reflected RF signal of an RF transmission on the RF antenna. The processor is also configured to analyze the characteristic information with a machine-learning-based classifier to determine, based on the characteristic information, a proximity characterization that indicates whether an object is within a threshold proximity to the RF antenna. The processor is also configured to control, based on the proximity characterization, a power back-off level of the RF transmission.

Example 2 is the device of example 1, wherein the proximity characterization includes a separation distance between the object and the RF antenna.

Example 3 is the device of example 2, wherein the processor is further configured to determine the power back-off level as a function of the separation distance.

Example 4 is the device of any one of examples 1 to 3, wherein the proximity characterization includes a classification of the object.

Example 5 is the device of example 4, wherein the processor is further configured to determine the power back-off level as a function of the classification.

Example 6 is the device of either one of examples 4 and 5, wherein the classification includes a type of object that is within the threshold proximity to the RF antenna.

Example 7 is the device of example 6, wherein the type of object includes at least one of a head, a torso, a cheek, a palm, a wrist, a foot, an ankle, an abdomen, or a non-human object.

Example 8 is the device of any one of examples 1 to 7, wherein the characteristic information further includes a ratio between the incident RF signal and the reflected RF signal.

Example 9 is the device of example 8, wherein the ratio includes a voltage standing wave ratio (VSWR) between the incident RF signal and the reflected RF signal.

Example 10 is the device of any one of examples 1 to 9, wherein the characteristic information further includes a return loss between the incident RF signal and the reflected RF signal.

Example 11 is the device of any one of examples 1 to 10, wherein the characteristic information that includes the incident RF signal includes an in-phase component of the incident RF signal and a quadrature component of the incident RF signal.

Example 12 is the device of any one of examples 1 to 11, wherein the characteristic information that includes the reflected RF signal includes an in-phase component of the reflected RF signal and a quadrature component of the reflected RF signal.

Example 13 is the device of any one of examples 1 to 12, wherein the characteristic information further includes an RF channel of the RF transmission.

Example 14 is the device of any one of examples 1 to 13, wherein the characteristic information further includes an operating temperature at the RF antenna.

Example 15 is the device of any one of examples 1 to 14, wherein the characteristic information further includes a frequency band of the RF transmission.

Example 16 is the device of any one of examples 1 to 15, the device further including a memory configured to store the machine-learning-based classifier.

Example 17 is the device of any one of examples 1 to 16, the device further including the RF antenna.

Example 18 is the device of any one of examples 1 to 17, wherein the processor configured to control the power back-off level of the RF transmission includes the processor configured to send an instruction to a transceiver that is coupled to the RF antenna, wherein the instruction indicates the power back-off level.

Example 19 is the device of example 18, the device further including the transceiver.

Example 20 is the device of any one of examples 1 to 19, wherein the processor configured to analyze the characteristic information includes the processor configured to analyze the characteristic information with a plurality of machine-learning-based classifiers, each associated with a corresponding one of a plurality of proximity classifications, wherein the machine-learning-based classifier includes one of the plurality of machine-learning-based classifiers and the proximity classification includes one of the plurality of proximity classifications.

Example 21 is the device of any one of examples 1 to 20, wherein the characteristic information includes an input to the machine-learning-based classifier and the proximity characterization includes an output of the machine-learning-based classifier.

Example 22 is the device of any one of examples 1 to 21, wherein the characteristic information includes an average of measured samples of the incident RF signal and the reflected RF signal.

Example 23 is a method that includes receiving characteristic information about a radio frequency (RF) antenna, wherein the characteristic information represents an incident RF signal and a reflected RF signal of an RF transmission on the RF antenna. The method also includes analyzing the characteristic information with a machine-learning-based classifier to determine, based on the characteristic information, a proximity characterization that indicates whether an object is within a threshold proximity to the RF antenna. The method also includes controlling, based on the proximity characterization, a power back-off level of the RF transmission.

Example 24 is the method of example 23, wherein the proximity characterization includes a separation distance between the object and the RF antenna.

Example 25 is the method of example 24, wherein the method further includes determining the power back-off level as a function of the separation distance.

Example 26 is the method of any one of examples 23 to 25, wherein the proximity characterization includes a classification of the object.

Example 27 is the method of example 26, wherein the method further includes determining the power back-off level as a function of the classification.

Example 28 is the method of either one of examples 26 and 27, wherein the classification includes a type of object that is within the threshold proximity to the RF antenna.

Example 29 is the method of example 28, wherein the type of object includes at least one of a head, a torso, a cheek, a palm, a wrist, a foot, an ankle, an abdomen, or a non-human object.

Example 30 is the method of any one of examples 23 to 29, wherein the characteristic information further includes a ratio between the incident RF signal and the reflected RF signal.

Example 31 is the method of example 30, wherein the ratio includes a voltage standing wave ratio (VSWR) between the incident RF signal and the reflected RF signal.

Example 32 is the method of any one of examples 23 to 31, wherein the characteristic information further includes a return loss between the incident RF signal and the reflected RF signal.

Example 33 is the method of any one of examples 23 to 32, wherein the characteristic information that includes the incident RF signal includes an in-phase component of the incident RF signal and a quadrature component of the incident RF signal.

Example 34 is the method of any one of examples 23 to 33, wherein the characteristic information that includes the reflected RF signal includes an in-phase component of the reflected RF signal and a quadrature component of the reflected RF signal.

Example 35 is the method of any one of examples 23 to 34, wherein the characteristic information further includes an RF channel of the RF transmission.

Example 36 is the method of any one of examples 23 to 35, wherein the characteristic information further includes an operating temperature at the RF antenna.

Example 37 is the method of any one of examples 23 to 36, wherein the characteristic information further includes a frequency band of the RF transmission.

Example 38 is the method of any one of examples 23 to 37, the method further includes storing the machine-learning-based classifier (e.g., in a memory).

Example 39 is the method of any one of examples 23 to 38, the method further including transmitting the RF transmission on the RF antenna.

Example 40 is the method of any one of examples 23 to 39, wherein controlling the power back-off level of the RF transmission includes sending an instruction to a transceiver that is coupled to the RF antenna, wherein the instruction indicates the power back-off level.

Example 41 is the method of example 40, the method further including transmitting the RF transmission via the transceiver.

Example 42 is the method of any one of examples 23 to 41, wherein analyzing the characteristic information includes analyzing the characteristic information with a plurality of machine-learning-based classifiers, each associated with a corresponding one of a plurality of proximity classifications, wherein the machine-learning-based classifier includes one of the plurality of machine-learning-based classifiers and the proximity classification includes one of the plurality of proximity classifications.

Example 43 is the method of any one of examples 23 to 42, wherein the characteristic information includes an input to the machine-learning-based classifier and the proximity characterization includes an output of the machine-learning-based classifier.

Example 44 is the method of any one of examples 23 to 43, wherein the characteristic information includes an average of measured samples of the incident RF signal and the reflected RF signal.

Example 45 is an apparatus that includes a means for receiving characteristic information about a radio frequency (RF) antenna, wherein the characteristic information represents an incident RF signal and a reflected RF signal of an RF transmission on the RF antenna. The apparatus also includes a means for analyzing the characteristic information with a machine-learning-based classifier to determine, based on the characteristic information, a proximity characterization that indicates whether an object is within a threshold proximity to the RF antenna. The apparatus also includes a means for controlling, based on the proximity characterization, a power back-off level of the RF transmission.

Example 46 is the apparatus of example 45, wherein the proximity characterization includes a separation distance between the object and the RF antenna.

Example 47 is the apparatus of example 46, wherein the apparatus further includes a means for determining the power back-off level as a function of the separation distance.

Example 48 is the apparatus of any one of examples 45 to 47, wherein the proximity characterization includes a classification of the object.

Example 49 is the apparatus of example 48, wherein the apparatus further includes a means for determining the power back-off level as a function of the classification.

Example 50 is the apparatus of either one of examples 48 and 49, wherein the classification includes a type of object that is within the threshold proximity to the RF antenna.

Example 51 is the apparatus of example 50, wherein the type of object includes at least one of a head, a torso, a cheek, a palm, a wrist, a foot, an ankle, an abdomen, or a non-human object.

Example 52 is the apparatus of any one of examples 45 to 51, wherein the characteristic information further includes a ratio between the incident RF signal and the reflected RF signal.

Example 53 is the apparatus of example 52, wherein the ratio includes a voltage standing wave ratio (VSWR) between the incident RF signal and the reflected RF signal.

Example 54 is the apparatus of any one of examples 45 to 53, wherein the characteristic information further includes a return loss between the incident RF signal and the reflected RF signal.

Example 55 is the apparatus of any one of examples 45 to 54, wherein the characteristic information that includes the incident RF signal includes an in-phase component of the incident RF signal and a quadrature component of the incident RF signal.

Example 56 is the apparatus of any one of examples 45 to 55, wherein the characteristic information that includes the reflected RF signal includes an in-phase component of the reflected RF signal and a quadrature component of the reflected RF signal.

Example 57 is the apparatus of any one of examples 45 to 56, wherein the characteristic information further includes an RF channel of the RF transmission.

Example 58 is the apparatus of any one of examples 45 to 57, wherein the characteristic information further includes an operating temperature at the RF antenna.

Example 59 is the apparatus of any one of examples 45 to 58, wherein the characteristic information further includes a frequency band of the RF transmission.

Example 60 is the apparatus of any one of examples 45 to 59, the apparatus further including a means for storing (e.g., in a memory) the machine-learning-based classifier.

Example 61 is the apparatus of any one of examples 45 to 60, the apparatus further including a means for transmitting the RF transmission on the RF antenna.

Example 62 is the apparatus of any one of examples 45 to 61, wherein the means for controlling the power back-off level of the RF transmission includes a means for sending an instruction to a transceiver that is coupled to the RF antenna, wherein the instruction indicates the power back-off level.

Example 63 is the apparatus of example 62, the apparatus further including a means for transmitting the RF transmission via the transceiver.

Example 64 is the apparatus of any one of examples 45 to 63, wherein the means for analyzing the characteristic information includes a means for analyzing the characteristic information with a plurality of machine-learning-based classifiers, each associated with a corresponding one of a plurality of proximity classifications, wherein the machine-learning-based classifier includes one of the plurality of machine-learning-based classifiers and the proximity classification includes one of the plurality of proximity classifications.

Example 65 is the apparatus of any one of examples 45 to 64, wherein the characteristic information includes an input to the machine-learning-based classifier and the proximity characterization includes an output of the machine-learning-based classifier.

Example 66 is the apparatus of any one of examples 45 to 65, wherein the characteristic information includes an average of measured samples of the incident RF signal and the reflected RF signal.

Example 67 is a non-transitory computer readable medium that includes instructions which, if executed, cause one or more processors to receive characteristic information about a radio frequency (RF) antenna, wherein the characteristic information represents an incident RF signal and a reflected RF signal of an RF transmission on the RF antenna. The instructions also cause the one or more processors to analyze the characteristic information with a machine-learning-based classifier to determine, based on the characteristic information, a proximity characterization that indicates whether an object is within a threshold proximity to the RF antenna. The instructions also cause the one or more processors to control, based on the proximity characterization, a power back-off level of the RF transmission.

Example 68 is the non-transitory computer readable medium of example 67, wherein the proximity characterization includes a separation distance between the object and the RF antenna.

Example 69 is the non-transitory computer readable medium of example 68, wherein the instructions also cause the one or more processors to determine the power back-off level as a function of the separation distance.

Example 70 is the non-transitory computer readable medium of any one of examples 67 to 69, wherein the proximity characterization includes a classification of the object.

Example 71 is the non-transitory computer readable medium of example 70, wherein the instructions also cause the one or more processors to determine the power back-off level as a function of the classification.

Example 72 is the non-transitory computer readable medium of either one of examples 70 and 71, wherein the classification includes a type of object that is within the threshold proximity to the RF antenna.

Example 73 is the non-transitory computer readable medium of example 72, wherein the type of object includes at least one of a head, a torso, a cheek, a palm, a wrist, a foot, an ankle, an abdomen, or a non-human object.

Example 74 is the non-transitory computer readable medium of any one of examples 67 to 73, wherein the characteristic information further includes a ratio between the incident RF signal and the reflected RF signal.

Example 75 is the non-transitory computer readable medium of example 74, wherein the ratio includes a voltage standing wave ratio (VSWR) between the incident RF signal and the reflected RF signal.

Example 76 is the non-transitory computer readable medium of any one of examples 67 to 75, wherein the characteristic information further includes a return loss between the incident RF signal and the reflected RF signal.

Example 77 is the non-transitory computer readable medium of any one of examples 67 to 76, wherein the characteristic information that includes the incident RF signal includes an in-phase component of the incident RF signal and a quadrature component of the incident RF signal.

Example 78 is the non-transitory computer readable medium of any one of examples 67 to 77, wherein the characteristic information that includes the reflected RF signal includes an in-phase component of the reflected RF signal and a quadrature component of the reflected RF signal.

Example 79 is the non-transitory computer readable medium of any one of examples 67 to 78, wherein the characteristic information further includes an RF channel of the RF transmission.

Example 80 is the non-transitory computer readable medium of any one of examples 67 to 79, wherein the characteristic information further includes an operating temperature at the RF antenna.

Example 81 is the non-transitory computer readable medium of any one of examples 67 to 80, wherein the characteristic information further includes a frequency band of the RF transmission.

Example 82 is the non-transitory computer readable medium of any one of examples 67 to 81, wherein the instructions further cause the one or more processors to store the machine-learning-based classifier (e.g., in a memory).

Example 83 is the non-transitory computer readable medium of any one of examples 67 to 82, wherein the instructions that cause the one or more processors to control the power back-off level of the RF transmission includes that the instructions cause the one or more processors to send an power instruction to a transceiver that is coupled to the RF antenna, wherein the power instruction indicates the power back-off level.

Example 84 is the non-transitory computer readable medium of any one of examples 67 to 83, wherein the instructions that cause the one or more processors to analyze the characteristic information includes that the instructions cause the one or more processors to analyze the characteristic information with a plurality of machine-learning-based classifiers, each associated with a corresponding one of a plurality of proximity classifications, wherein the machine-learning-based classifier includes one of the plurality of machine-learning-based classifiers and the proximity classification includes one of the plurality of proximity classifications.

Example 85 is the non-transitory computer readable medium of any one of examples 67 to 84, wherein the characteristic information includes an input to the machine-learning-based classifier and the proximity characterization includes an output of the machine-learning-based classifier.

Example 86 is the non-transitory computer readable medium of any one of examples 67 to 85, wherein the characteristic information includes an average of measured samples of the incident RF signal and the reflected RF signal.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1. A device comprising a processor configured to:
receive characteristic information about a radio frequency (RF) antenna, wherein the characteristic information represents an incident RF signal and a reflected RF signal of an RF transmission on the RF antenna;
analyze the characteristic information with a machine-learning-based classifier to determine, based on the characteristic information, a proximity characterization that indicates whether an object is within a threshold proximity to the RF antenna; and
control, based on the proximity characterization, a power back-off level of the RF transmission.

2. The device of claim 1, wherein the proximity characterization comprises a separation distance between the object and the RF antenna.

3. The device of claim 2, wherein the processor is further configured to determine the power back-off level as a function of the separation distance.

4. The device of claim 1, wherein the proximity characterization comprises a classification of the object.

5. The device of claim 4, wherein the processor is further configured to determine the power back-off level as a function of the classification.

6. The device of claim 4, wherein the classification comprises a type of object that is within the threshold proximity to the RF antenna.

7. The device of claim 6, wherein the type of object comprises at least one of a head, a torso, a cheek, a palm, a wrist, a foot, an ankle, an abdomen, or a non-human object.

8. The device of claim 1, wherein the characteristic information that comprises the incident RF signal comprises an in-phase component of the incident RF signal and a quadrature component of the incident RF signal.

9. The device of claim 1, wherein the characteristic information that comprises the reflected RF signal comprises an in-phase component of the reflected RF signal and a quadrature component of the reflected RF signal.

10. The device of claim 1, wherein the characteristic information further comprises an RF channel of the RF transmission.

11. The device of claim 1, wherein the characteristic information further comprises an operating temperature at the RF antenna.

12. The device of claim 1, wherein the characteristic information further comprises a frequency band of the RF transmission.

13. The device of claim 1, the device further comprising a memory configured to store the machine-learning-based classifier.

14. The device of claim 1, wherein the processor configured to control the power back-off level of the RF transmission comprises the processor configured to send an instruction to a transceiver that is coupled to the RF antenna, wherein the instruction indicates the power back-off level.

15. The device of claim 1, wherein the processor configured to analyze the characteristic information comprises the processor configured to analyze the characteristic information with a plurality of machine-learning-based classifiers, each associated with a corresponding one of a plurality of proximity classifications, wherein the machine-learning-based classifier comprises one of the plurality of machine-learning-based classifiers and the proximity classification comprises one of the plurality of proximity classifications.

16. The device of claim 1, wherein the characteristic information comprises an average of measured samples of the incident RF signal and the reflected RF signal.

17. A non-transitory computer readable medium comprising instructions which, if executed, cause one or more processors to:
receive characteristic information about a radio frequency (RF) antenna, wherein the characteristic information represents an incident RF signal and a reflected RF signal of an RF transmission on the RF antenna;
analyze the characteristic information with a machine-learning-based classifier to determine, based on the characteristic information, a proximity characterization that indicates whether an object is within a threshold proximity to the RF antenna; and
control, based on the proximity characterization, a power back-off level of the RF transmission.

18. The non-transitory computer readable medium of claim 17, wherein the characteristic information that represents the incident RF signal comprises an in-phase component of the incident RF signal and a quadrature component of the incident RF signal and also comprises an in-phase component of the reflected RF signal and a quadrature component of the reflected RF signal.

19. An apparatus comprising:
a means for receiving a characteristic information about a radio frequency (RF) antenna, wherein the characteristic information represents an incident RF signal and a reflected RF signal of an RF transmission on the RF antenna;
a means for analyzing the characteristic information with a machine-learning-based classifier to determine, based on the characteristic information, a proximity characterization that indicates whether an object is within a threshold proximity to the RF antenna; and
a means for controlling, based on the proximity characterization, a power back-off level of the RF transmission.

20. The apparatus of claim 19, wherein the characteristic information comprises an RF channel of the RF transmission.
